(19) United States
(12) Patent Application Publication
(10) Pub. No.: US 2015/0368079 A1
(43) Pub. Date: Dec. 24, 2015

(54) LOAD SUPPORTING AND ORIENTING APPARATUS FOR A LIFT DEVICE

(71) Applicants: Joshua Scholfield, Phoenix, AZ (US); David E. Zuckerman, Phoenix, AZ (US); Raymond S. Zuckerman, Scottsdale, AZ (US)

(72) Inventors: Joshua Scholfield, Phoenix, AZ (US); David E. Zuckerman, Phoenix, AZ (US); Raymond S. Zuckerman, Scottsdale, AZ (US)

(73) Assignee: SERVERLIFT CORPORATION, Phoenix, AZ (US)

(21) Appl. No.: 14/310,798

(22) Filed: Jun. 20, 2014

(51) Int. Cl. B66F 9/16

(52) U.S. Cl. CPC B66F 9/16

(57) ABSTRACT

A lift apparatus includes a lift device operable for raising and lowering a first platform, a base releasably connected atop the first platform, a second platform mounted to the base for tiltable movement between a first position and a second position relative to the first platform, the second position of the second platform being tilted relative to the first position of the second platform, and a retention assembly coupled between the base and the second platform for selectively tilting the second platform from the first position to the second position, and selectively retaining the second platform in the first position and in the second position.

### FIELD OF THE INVENTION

The present invention relates generally to lift devices for lifting and lowering loads, especially sensitive loads, such as computer equipment, scientific equipment, and telephony equipment.

### BACKGROUND OF THE INVENTION

Lift devices are commonly used to lift workers and equipment during construction, painting, maintenance, assembly, installation, and manufacturing operations. Of particular significance are lifts designed for lifting and lowering sensitive loads, such as computer equipment, telephony equipment, scientific equipment, and the like, that are required to be installed onto racks, cabinets, elevated supports or support surfaces, or the like. Such sensitive equipment is heavy and/or unwieldy thereby necessitating the use of a lift device for equipment maneuvering purposes. Although existing lift devices are useful for lifting sensitive equipment to an installation location, aligning and transferring such equipment from the lift device to a selected installation location is difficult and cumbersome. Also, some types of sensitive equipment must be carefully leveled or oriented in a pre-selected orientation during lifting and maneuvering, such as for preventing unwanted equipment damage or to prevent such equipment from becoming uncalibrated, which functions existing lifting devices are not structured to perform. Given these and other shortcomings, the need for continued improvement in the art is evident.

### SUMMARY OF THE INVENTION

According to the principle of the invention, a lift apparatus includes a lift device operable for raising and lowering a first platform, a base connected atop the first platform, a second platform mounted to the base for tiltable movement between a first position and a second position relative to the first platform, and a retention assembly coupled between the base and the second platform for selectively tilting the second platform from the first position to the second position, and selectively retaining the second platform in the first position and in the second position, the second position of the second platform being tilted relative to the first position of the second platform. The retention assembly includes a pivot connection connecting the second platform to the base for pivotal tilting movement of the second platform between the first position and the second position, and a linkage assembly interacting between the base and the second platform, the linkage assembly being adjustable between a collapsed configuration and an extended configuration for imparting corresponding pivotal movement of the second platform at the pivot connection from the first position to the second position. The pivot connection and the collapsed configuration of the linkage assembly cooperate to retain the second platform in the first position. The pivot connection and the extended configuration of the linkage assembly cooperate to retain the second platform in the second position. An adjustment member is coupled to the linkage assembly for selectively retaining the linkage assembly in the collapsed and extended configurations, and selectively adjusting the linkage assembly between the collapsed and extended configurations. The adjustment member is rotatably carried by the linkage assembly, wherein rotation of the adjustment member urges corresponding adjustment of the linkage assembly between the collapsed and extended configurations, non-rotation of the adjustment member in the collapsed configuration of the linkage assembly retains the linkage assembly in the collapsed configuration, and non-rotation of the adjustment member in the extended configuration of the linkage assembly retains the linkage assembly in the extended configuration. The lift apparatus further includes blocks for interacting between the second platform and the base in the first position of the second platform for limiting movement of the second platform past the first position in a direction toward the first platform. The blocks included a first pair of blocks carried by the second platform aligned with a second pair of blocks carried by the base. The linkage assembly is connected to the first blocks and to the second blocks. A handle is connected to the adjustment member, and is available to be taken up by hand for imparting rotation to the adjustment member.

According to the principle of the invention, a lift apparatus includes a lift device operable for raising and lowering a first platform, a base connected atop the first platform, the base having opposed first and second ends, a second platform having opposed first and second ends, a pivot connection connecting the second platform proximate to the first end thereof to the base proximate to the first end thereof for selective pivotal tilting movement of the second platform between a first position and a second position relative to the first platform, the second position of the second platform being tilted relative to the first position of the second platform, and a linkage assembly interacting between the base and the second platform proximate to the second end of the base and the second end of the second platform, the linkage assembly being adjustable between a collapsed configuration and an extended configuration for imparting corresponding pivotal tilting movement of the second platform at the pivot connection from the first position to the second position. The pivot connection and the collapsed configuration of the linkage assembly cooperate to retain the second platform in the first position. The pivot connection and the extended configuration of the linkage assembly cooperate to retain the second platform in the second position. An adjustment member is coupled to the linkage assembly for selectively retaining the linkage assembly in the collapsed and extended orientations, and selectively adjusting the linkage assembly between the collapsed and extended orientations. The adjustment member is rotatably carried by the linkage assembly, wherein rotation of the adjustment member urges corresponding adjustment of the linkage assembly between the collapsed and extended orientations, non-rotation of the adjustment member in the collapsed orientation of the linkage assembly retains the linkage assembly in the collapsed orientation, and non-rotation of the adjustment member in the extended orientation of the linkage assembly retains the linkage assembly in the extended orientation. The lift apparatus further includes blocks for interacting between the second platform and the base in the first position of the second platform for limiting movement of the second platform past the first position in a direction toward the first platform. The blocks include a first pair of blocks carried by the second platform aligned with a second pair of blocks carried by the base. The linkage assembly is connected to the first blocks and to the second blocks. A handle is connected to the adjustment member and is available to be taken up by hand for imparting rotation to the adjustment member.

### BRIEF DESCRIPTION OF THE DRAWINGS

Referring to the drawings:

FIG. 1 is a perspective view of a lift device operative for raising and lowering a platform, and a load supporting and orienting apparatus carried by the platform and shown as it would appear in a closed position;

FIG. 2 is a view similar to that of FIG. 1 illustrating the apparatus in an opened position;

FIG. 3 is a top perspective view of the apparatus of FIG. 1 shown as it would appear in the closed position;

FIG. 4 is a bottom perspective view of the embodiment of FIG. 3;

FIG. 5 is a side perspective view of the embodiment of FIG. 3;

FIG. 6 is a side elevation view of the embodiment of FIG. 3;

FIG. 7 is a top perspective view of the apparatus of FIG. 2 shown as it would appear in the opened position;

FIG. 8 is a side perspective view of the embodiment of FIG. 7;

FIG. 9 is a side elevation view of the embodiment of FIG. 7;

FIG. 10 is an enlarged rear fragmented perspective view of a linkage assembly interacting between a platform and a base of the apparatus first illustrated in FIG. 1, the linkage assembly shown as it would appear in a collapsed configuration corresponding to the closed position of the apparatus;

FIG. 11 is an enlarged front perspective view of the linkage assembly of FIG. 10;

FIG. 12 is a frontal perspective view of the linkage assembly of FIG. 10 with portions of the apparatus being broken away for illustrative purposes;

FIG. 13 is a section view taken along line 13-13 of FIG. 12;

FIG. 14 is a view similar to that of FIG. 10 illustrating the linkage assembly as it would appear in an extended configuration corresponding to the opened position of the apparatus;

FIG. 15 is an enlarged front perspective view of the linkage assembly of FIG. 14 with portions of the apparatus being broken away for illustrative purposes; and

FIG. 16 is a section view taken along line 16-16 of FIG. 15.

### DETAILED DESCRIPTION

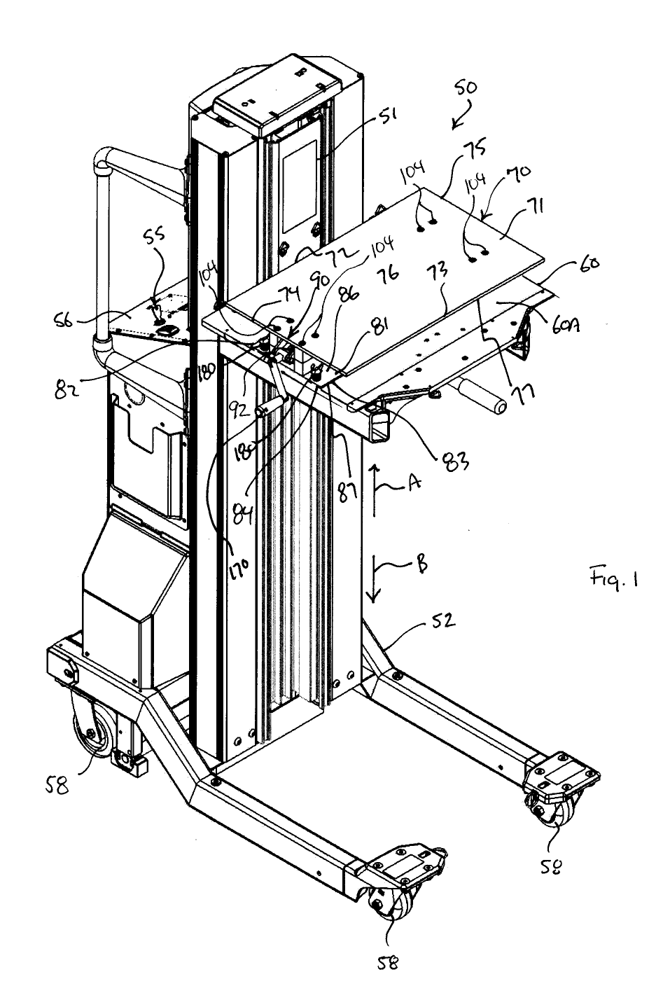

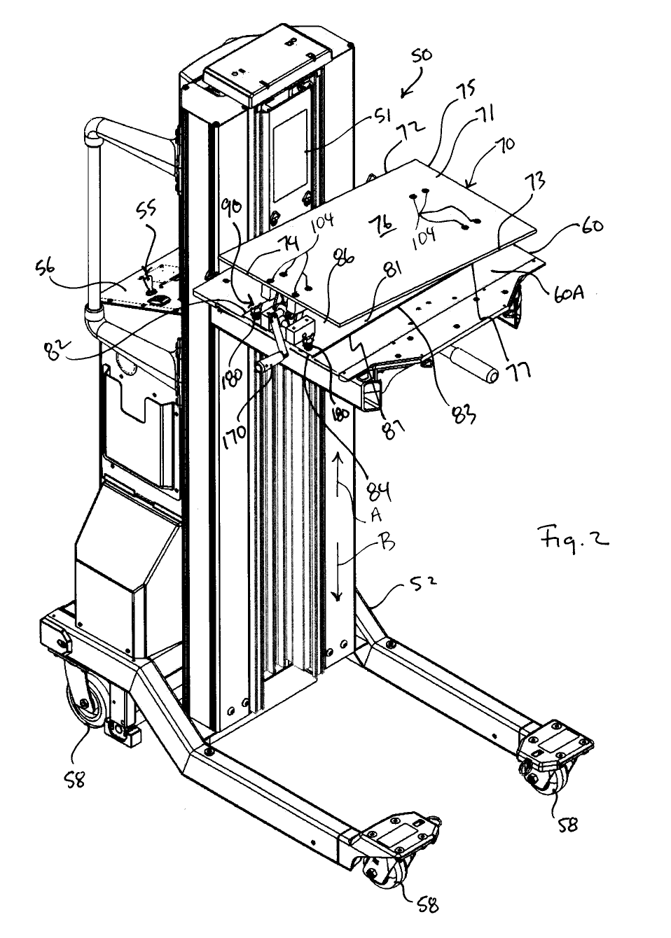

Turning now to the drawings, in which like reference characters indicate corresponding elements throughout the several views, attention is directed to FIGS. 1 and 2 illustrating lift device 50 operable for raising and lowering platform 60. Lift device 50 includes lifting mast 51 mounted to wheeled chassis 52. Platform 60 is mounted to lifting mast 51. Platform 60 is carried or otherwise supported by lifting mast 51, and has a load-supporting upper or top surface 60A. Load-supporting upper surface 60A is horizontal in this example and is used to receive loads to be lifted and lowered via the conventional operation of lift device 50. Lifting mast 51 is a raising and lowering mast of lift device 50 that is operable for raising and lowering platform 60. Lift device 50 incorporates a drive assembly denoted generally at 55. Drive assembly 55 is not shown in detail and is an entirely conventional and well-known motorized drive assembly carried by wheeled chassis 52 and is conventionally operable for moving lifting mast 51 in a lifting or raising direction indicated by arrowed line A and the opposite lowering direction indicated by arrowed line B for, in turn, raising and lowering platform 60. Drive assembly 55 is operated by an operator interface, which is control panel 56 formed in the rear of wheeled chassis 52. Drive assembly 55 incorporates a lifting circuit operable for engaging drive assembly 55 for moving lifting mast 51 in the raising direction in response operator control at control panel 56 for moving platform 60 in the raising direction, and incorporates a lowering circuit operative for engaging drive assembly 55 for moving lifting mast 51 in the lowering direction in response to operator control at control panel 56 for moving platform 60 in the lowering direction. These lifting and lowering circuits are different from one another and are conventional and are activated in response to the operation of lift device 50 from control panel 56. Platform 60 is attached to lifting mast 51, and movement of lifting mast 51 in the lifting and lowering directions between raised and lowered positions of lifting mast 51 causes a corresponding movement of load-supporting assembly 60 in lifting and lowering directions between a lowered position of platform 60 in the lowered position of lifting mast 51 and a raised or lifted position of platform 60 in the raised or lifted position of lifting mast 51 for facilitating the lifting and lowering of a load, such as equipment or material, placed on platform 60. Wheeled chassis 52 includes wheels 58 to permit wheeled movement of lift device 50 over the ground, the floor, or other surface. Two or more of wheels 58 are steerable. The operation of lift device 50 is controlled by hand and from control panel 56, in which lifting mast 51 may be moved in the lowering and raising directions and lift device 50 may be rolled over a surface according to the needs of the worker.

Lift device 50 is generally representative of a conventional and well-known motorized lifting device operable for raising and lowering platform 60, further details of which will readily occur to the skilled artisan and will not be discussed in further detail. Although lift device 50 is motorized to provide the motorized raising and lowering of platform 60, lift device 50 may be conventionally configured as a manually operated lift device that is operated manually in the raising and lowering platform 60.

In FIGS. 1 and 2 there is illustrated a load supporting and orienting apparatus denoted generally at 70. Apparatus 70 is constructed and arranged in accordance with the principle of the invention, is applied to and is carried by and atop platform 60, and is useful for receiving loads and orienting loads in pre-selected orientations relative to platform 60 according to the needs of the worker, such as for assisting the worker leveling loads, and for assisting the worker with equipment installation procedures, such as installing computer equipment, including computer servers, onto specially designed racks or cabinets. According to this disclosure, the combination of lift device 50 and apparatus 70 forms a lift apparatus. Apparatus 70 is selectively adjustable between a first or closed position/configuration and a second or opened position/configuration. In FIG. 1 apparatus 70 as it would appear in the closed position for orienting a load placed thereon in a pre-selected orientation depending on the needs of the worker, and in FIG. 2 apparatus 70 is shown as it would appear in the opened position for orientating a load placed thereon in a different pre-selected orientation depending on the needs of the worker.

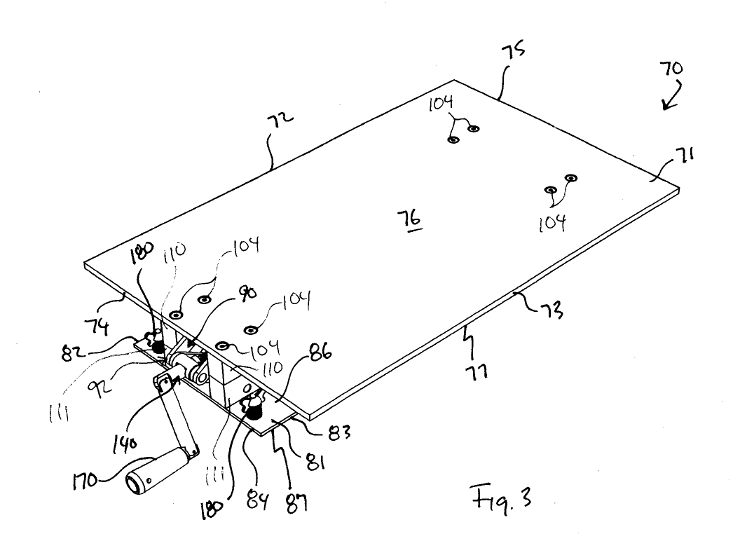

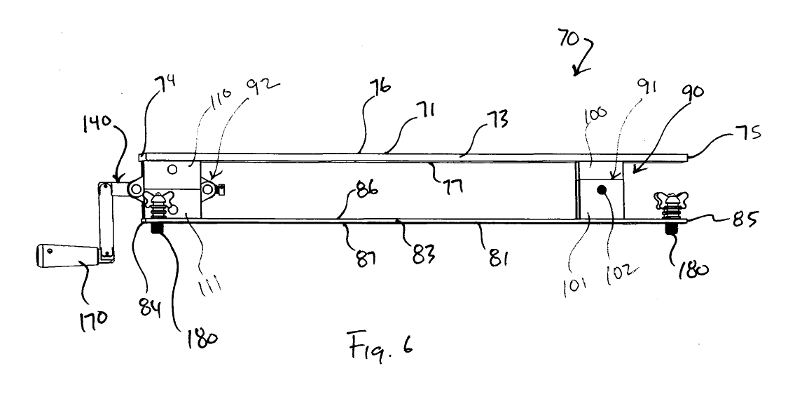

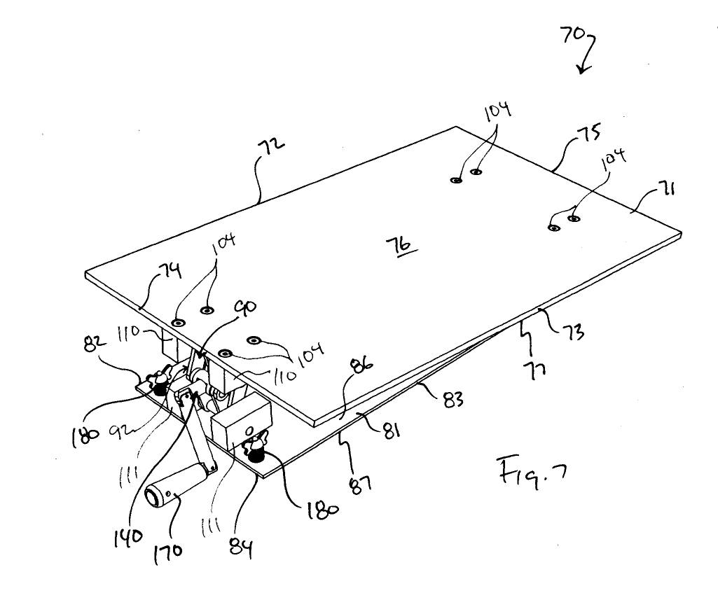

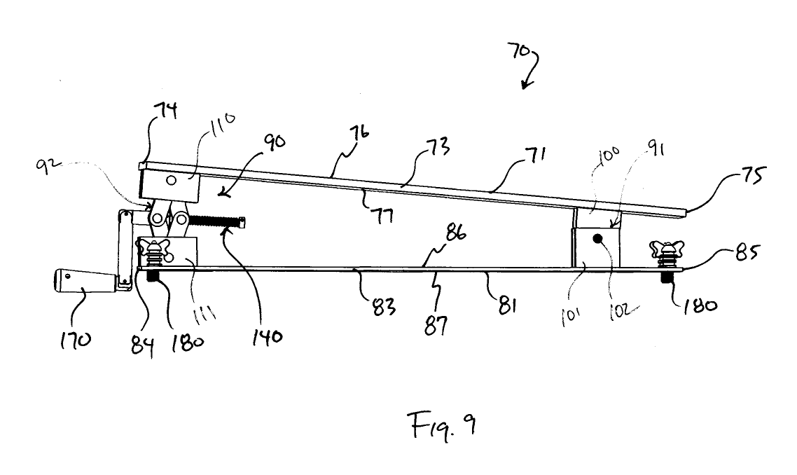

Referencing FIGS. 1-9 in relevant part, apparatus 70 includes platform 71, base 81, and retention assembly denoted generally at 90. Retention assembly 90 connects platform 71 to base 81, and is used to independently adjust platform 71 between a first or closed position corresponding to the first or closed position or configuration of apparatus 70, and a second or open position corresponding to the second or open position or configuration of apparatus 70, and is used to selectively retain platform 71 in its first or closed position corresponding to the first or closed position or configuration of apparatus 70, and its second or open position corresponding to the second or open position or configuration of apparatus 70. Platform 71 is fashioned of plastic, metal, wood, or other like or similar material or combination of materials having inherently strong, resilient, and impact resistant material characteristics. Platform 71 is planar, and is rectangular in shape in this example, and has opposed, parallel edges or sides 72 and 73 that extend between comparatively shorter opposed, parallel edges or ends 74 and 75, load-supporting top or upper surface 76, and opposed, parallel bottom or under surface 77. Like platform 71, base 81 is fashioned of plastic, metal, wood, or other like or similar material or combination of materials having inherently strong and resilient and impact resistant material characteristics. Base 81 is planar, and is rectangular in shape in this example, and has opposed, parallel edges or sides 82 and 83 that extend between comparatively shorter opposed, parallel edges or ends 84 and 85, top or upper surface 86, and opposed, parallel bottom or under surface 87.

Retention assembly 90 connects platform 71 to base 81. Retention assembly 90 is positioned and coupled between under surface 77 of platform 71 and upper surface 86 of base 81. Retention assembly 90 holds platform 71 in superimposition over, and spaced-apart from, base 81, whereby under surface 77 of platform 71 and upper surface 86 of base 81 are aligned and juxtaposed, side 72 of platform 71 and side 82 of base 81 are aligned and juxtaposed, side 73 of platform 71 and side 83 of base 81 are aligned and juxtaposed, end 74 of platform 71 and end 84 of base 81 are aligned and juxtaposed, and end 75 of platform 71 and end 85 of base 81 are aligned and juxtaposed. Platform 71 and base 81 concurrently extend in a longitudinal direction from ends 74 and 84 to ends 74 and 85, and concurrently extend in a transverse direction relative to the longitudinal direction from sides 72 and 82 to sides 73 and 83. Retention assembly 90 connects platform 71 to base 81 for independent selective movement of platform 71 relative to base 81 between its first or closed position in FIGS. 1 and 3-6 toward base 81 defining the first or closed position/configuration of apparatus 70, and its second or opened position in FIGS. 2 and 7-9 away from base 81 defining the second or opened position/configuration of apparatus 70. In the second or open position of platform 71, platform 71 and load-supporting upper surface 76 of platform 71 are tilted or otherwise inclined relative to platform 71, and also load-supporting upper surface 76 of platform 71, in the first or closed position of platform 71.

In this example, platform 71 is parallel relative to base 81 in the closed position of platform 71. In a further and more specific aspect, load-supporting upper surface 76 of platform 71 is parallel relative to upper surface 86 of base 81 in the closed position of platform 71. Platform 71 is inclined or otherwise tilted upwardly from end 75 to end 74 relative to base 81 in the opened position of platform 71 at an angle of inclination of, for example from approximately 10 degrees from the horizontal to approximately 20 degrees from the horizontal. In alternate embodiments, other degrees of inclination can be used. In a further and more specific aspect, load-supporting upper surface 76 of platform 71 is inclined or otherwise tilted upwardly from end 75 to end 74 relative to upper surface 86 of base 81 in the opened position of platform 71 at an angle of inclination of, for example, from approximately 10 degrees from the horizontal to approximately 20 degrees from the horizontal. In alternate embodiments, other degrees of inclination can be used. Apparatus 70 can be configured to set platform 71, and thus load-supporting upper surface 76 of platform, at other selected angles of inclination in the opened position of platform 71 depending on the needs of the worker. And so in the closed position of platform 71, platform 71 and load-supporting upper surface 76 are concurrently tilted down toward base 81 to a position that is parallel relative to base 81. In the opened position of platform 71, platform 71 and load-supporting upper surface 76 are concurrently tilted up and away from base 81 being inclined or tilted upwardly relative base 81 from end 75 to end 74.

Retention assembly 90 is coupled between base 81 and platform 71 and is operative for selectively and independently adjusting platform 71 between the closed position and the opened position, selectively retaining platform 71 in the closed position and the opened position, and selectively retaining platform 71 at any inclined or tilted position between the opened and closed positions, in accordance with the principle of the invention. Retention assembly 90 includes pivot connection 91 and linkage assembly 92 coupled between platform 71 and base 81. Pivot connection 91 pivotally connects platform 71 to base 871 for pivotal movement of platform 71 between the closed position in FIGS. 1 and 3-6 and the opened position in FIGS. 2 and 7-9. Linkage assembly interacts between platform 71 and base 81 and is adjustable between a first or collapsed configuration and a second or extended configuration for imparting corresponding pivotal tilting movement of platform 71 at pivot connection 91 from the closed position, corresponding to the collapsed configuration of linkage assembly 92, to the opened position corresponding to the extended configuration of linkage assembly 92, and also from the opened position back to the closed position. Pivot connection 91 and the collapsed configuration of linkage assembly 92 cooperate to retain platform 71 in the closed position. Pivot connection 91 and the extended configuration of linkage assembly 92 cooperate to retain platform 71 in the opened position. Pivot connection 91 any partially extended or partially collapsed configuration of linkage assembly 92 cooperate to retain platform 71 in any position between the closed position of platform 71 and the opened position of platform 71.

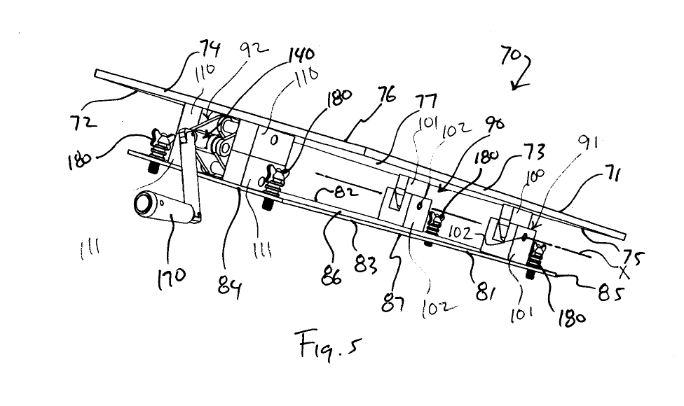

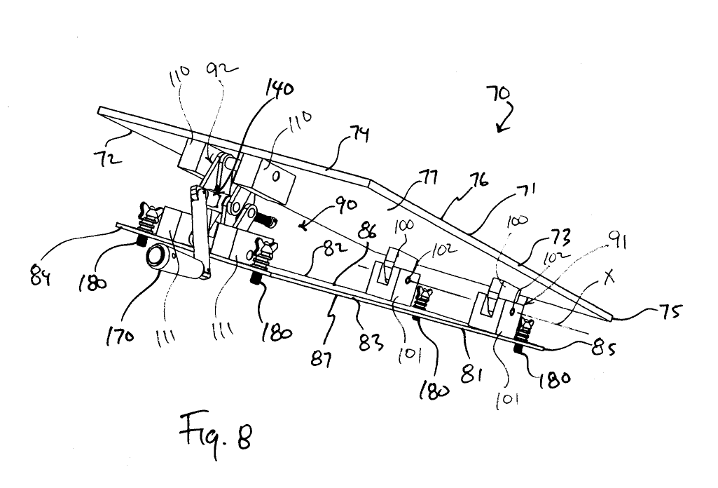

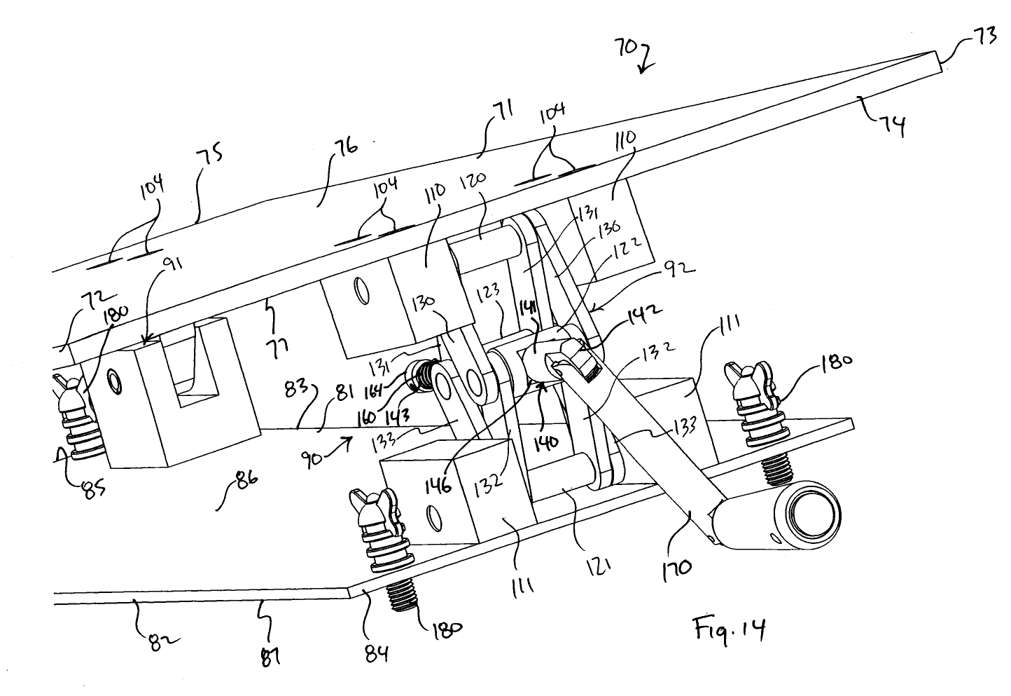

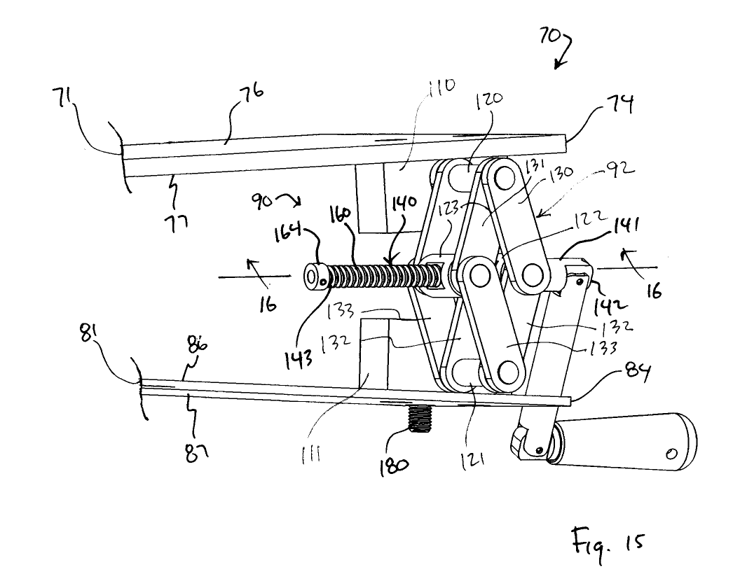

In FIGS. 5 and 8, pivot connection 91 connects platform 71 proximate to end 75 to base 81 proximate to end 85 for selective pivotal tilting movement of platform 71 between the closed position in FIGS. 1 and 3-6, and the opened position in FIGS. 2 and 7-9. Linkage assembly 92, in turn, interacts between base 81 and platform 71 proximate to end 84 of base 81 and end 74 of platform 71, and is selectively adjustable between the collapsed configuration in FIGS. 1, 3-6, 10-12, and the extended configuration in FIGS. 2, 7-9, 14, and 15 for imparting corresponding pivotal tilting movement of platform at pivot connection 91 in FIGS. 5 and 8 back and forth from the closed position in FIGS. 1 and 3-6 corresponding to the collapsed configuration of linkage assembly 92 to the opened position in FIGS. 2 and 7-9 corresponding to the extended configuration of linkage assembly 92.

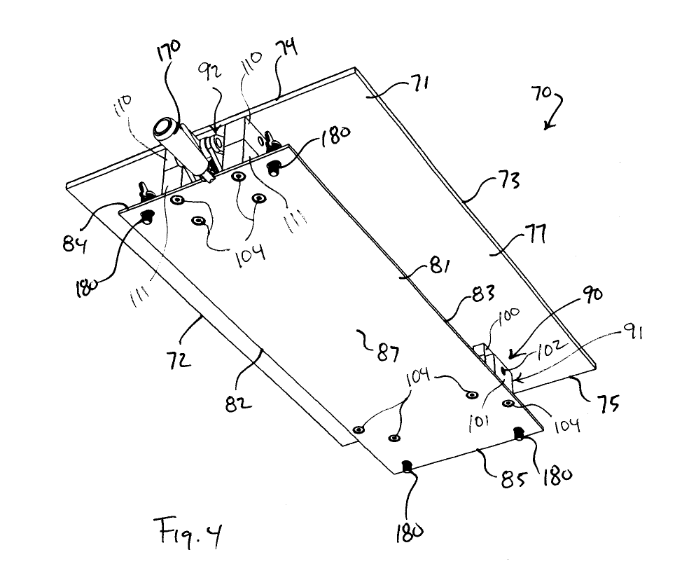

In FIGS. 5 and 8, pivot connection 91 includes axially aligned lugs 100 rigidly affixed to under surface 77 of platform 71 near end 75 mounted for pivotal movement to corresponding axially aligned bifurcated brackets 101 rigidly affixed to upper surface 86 of base 81 near end 85 with respective pivot pins 102. Lugs 100 depend downwardly from under surface 77 and are rigidly affixed to under surface 77 of platform 71 with mechanical fasteners, which, in the present embodiment, are threaded fasteners 104 denoted in FIGS. 1-3, 7, and 10, that are installed between platform 71 and lugs 100. Lugs 100 can be rigidly affixed to under surface 77 of platform 71 in other ways, such as via welding, adhesive, heat bonding, etc. Brackets 101 extend upwardly from upper surface 86 toward lugs 100 and are rigidly affixed to upper 86 of base 81 with mechanical fasteners, which, in the present embodiment, are threaded fasteners 104 denoted in FIG. 4, that are installed between base 81 and brackets 101. Brackets 101 can be rigidly affixed to upper surface 86 of base 81 in other ways, such as via welding, adhesive, heat bonding, etc. Platform 71 pivotally tilts at pivot pins 102 of pivot connection 91 about pivot axis X in FIGS. 5 and 8 along which pivot pins 102 reside between the closed position of platform 71, and thus of load-supporting upper surface 76 of platform 71, in FIG. 5 and the opened position of platform 71, and thus of load-supporting upper surface 76 of platform 71, in FIG. 8. Pivot axis X extends transversely relative to the longitudinal direction of platform 71 and base 81 from ends 74 and 84, respectively, to ends 75 and 85, respectively.

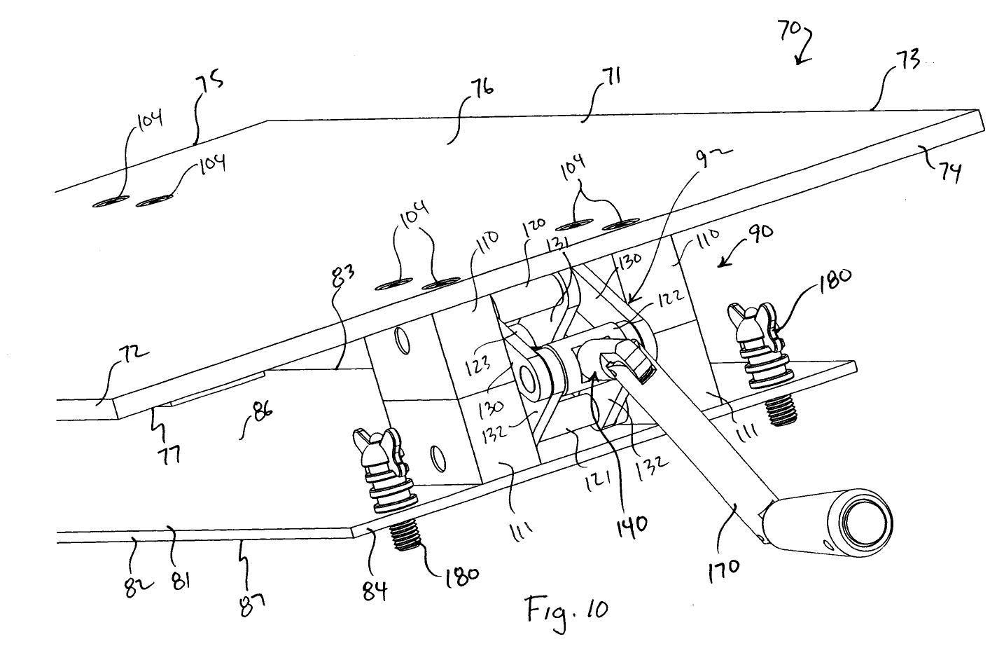

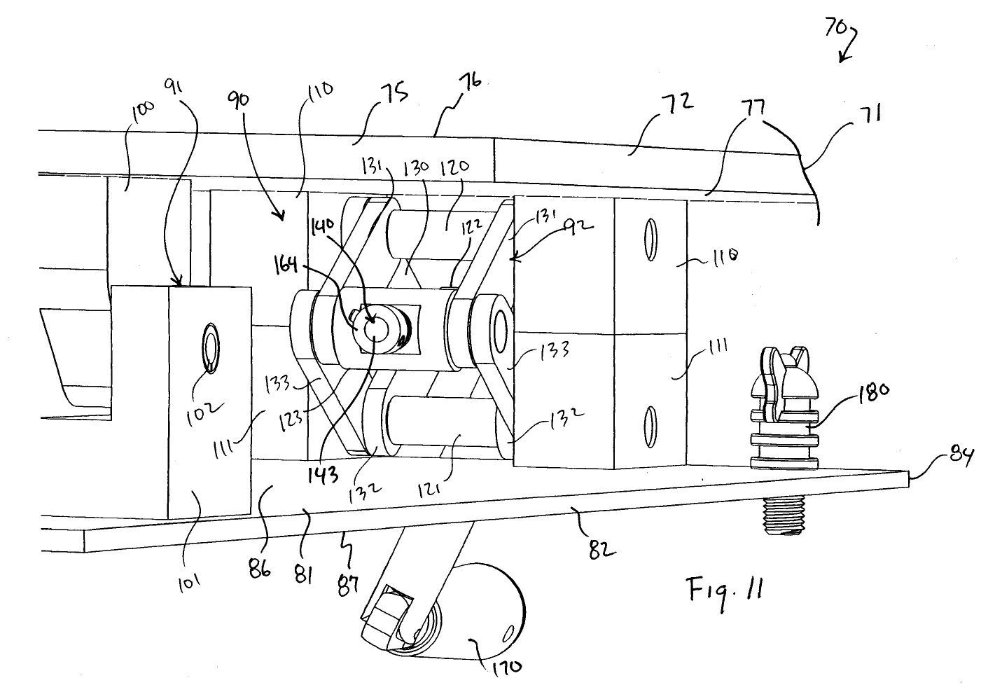

In FIGS. 10 and 11, linkage assembly 92 is located between undersurface 77 of platform 71 and upper surface 86 of base 81 proximate to ends 74 and 84 of platform 71 and base 81, respectively, and is equidistant with respect to sides 72 and 73 of platform 71 and with respect to sides 82 and 83 of base 81 as seen in FIG. 10. Axially aligned blocks 110 are rigidly affixed to under surface 77 of platform 71 near end 74 on either side of linkage assembly 92, and axially aligned blocks 111 are rigidly affixed to upper surface 86 of base 81 near end 84 on either side of linkage assembly 92. Blocks 110 and 111 are equal in size and shape in this example. The pair of blocks 110 and 111 on each side of linkage assembly 92 are axially aligned or otherwise diametrically opposed. Blocks 110 depend downwardly from under surface 77 and are rigidly affixed to under surface 77 of platform 71 with mechanical fasteners, which, in the present embodiment are threaded fasteners 104 denoted in FIGS. 1-3, and 7, that are installed between platform 71 and blocks 110. Blocks 110 can be rigidly affixed to under surface 77 of platform 71 in other ways, such as via welding, adhesive, heat bonding, etc. Blocks 111 extend upwardly from upper surface 86 and are rigidly affixed to upper 86 of base 81 with mechanical fasteners, which, in the present embodiment are threaded fasteners 104 denoted in FIG. 4, that are installed between base 81 and blocks 111. Blocks 111 can be rigidly affixed to upper surface 86 of base 81 in other ways, such as via welding, adhesive, heat bonding, etc. Blocks 110 are considered upper blocks, and blocks 111 are considered lower blocks.

Linkage assembly 92 is located between blocks 110 and between blocks 111. In this example, linkage assembly 92 is equidistant between sides 72 and 73 of platform 71 and sides 82 and 83 of base 81. Linkage assembly 92 is coupled to blocks 110 on either side of linkage assembly 92, and to blocks 111 on either side of linkage assembly 92. Referring in relevant part to FIGS. 10 and 11, linkage assembly 92 consists of opposed, axially-aligned diamond linkages pivoted to and held by a plurality of pins, including upper pin 120 extending between and connected to blocks 110, lower pin 121 extending between and connected to blocks 111, and intermediate back and front pins 122 and 123 between blocks 110 and 111. Upper and lower pins 120 and 121 are parallel relative to each other and are axially aligned in a vertical direction, and intermediate back and front pins 122 and 123 are parallel relative to each other and are axially aligned in a transverse or horizontal direction normal to the vertical direction of alignment of upper and lower pins 120 and 121.

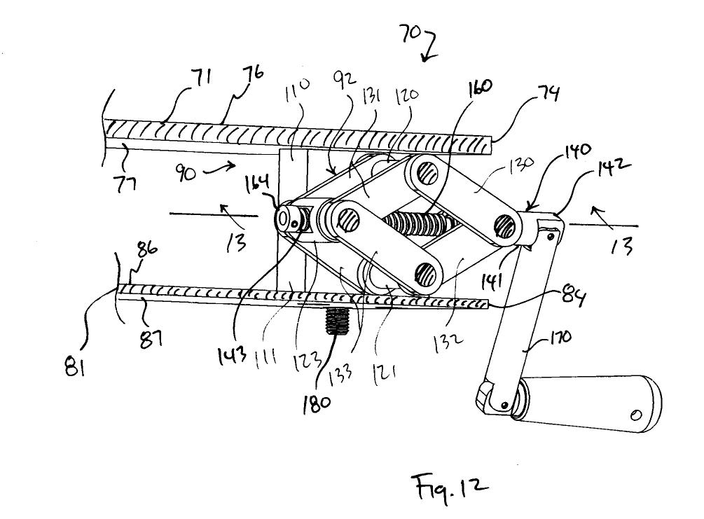

The diamond linkages are identical and are the mirror image of one another. Referring to FIGS. 12, 13, 15, and 16, the diamond linkages include opposed upper links 130 and 131 and opposed lower links 132 and 133 arranged in a diamond pattern. The upper ends of upper links 130 and 131 encircle, and are free to concurrently pivot about, opposite ends of upper pin 120 and the respective inner sides of blocks 110. Upper links 130 depend downwardly and rearwardly in a direction toward ends 74 and 84 of platform 71 and base 81, respectively, to their lower ends that encircle, and that are free to pivot about, opposite ends of intermediate back pin 122. Upper links 131 depend downwardly and forwardly in a direction away from ends 74 and 84 of platform 71 and base 81, respectively, to their lower ends that encircle, and that are free to pivot about, opposite ends of intermediate front pin 123. The lower ends of lower links 132 and 132 encircle, and are free to concurrently pivot about, opposite ends of lower pin 121 at the respective inner sides of blocks 111. Lower links 132 extend upward and rearwardly in a direction toward ends 74 and 84 of platform 71 and base 81, respectively, to their upper ends that encircle, and that are free to pivot about, the opposite ends of intermediate back pin 122. Lower links 133 extend upwardly and forwardly in a direction away from ends 74 and 84 of platform 71 and base 81, respectively, to their upper ends that encircle, and that are free to pivot about, the opposite ends of intermediate front pin 123. The described pivot connections connecting linkage assembly 92 to blocks 110 and 111 concurrently connects linkage assembly 92 to platform 71 and base 81. The described diamond linkages pivot about the respective pins 120-123 from the collapsed configuration of linkage assembly 92 in FIGS. 10-13 corresponding to the closed position of platform 71, and the extended configuration in FIGS. 1-16 corresponding to the opened position of platform 71. In the collapsed configuration corresponding to the closed position of platform 71 defining the closed position of apparatus 70, linkage assembly 92 is elongated in the horizontal direction from intermediate back pin 122 to intermediate front pin 123, and is shortened in the vertical direction from upper pin 122 to lower pin 23. In the extended configuration corresponding to the opened position of platform 71 defining the opened position of apparatus 70, linkage assembly 92 is shortened in the horizontal direction from intermediate back pin 122 to intermediate front pin 123, and is elongated in the vertical direction from upper pin 122 to lower pin 23.

Linkage assembly 92 is adjustable between the collapsed and extended configurations via the operation of adjustment member 140. Adjustment member 140 is coupled to linkage assembly 92 for selectively retaining linkage assembly 92 in the collapsed and extended configurations, and selectively adjusting linkage assembly 92 between the collapsed and extended configurations. More specifically, adjustment member 140 is rotatably carried by linkage assembly 92, wherein rotation of adjustment member 140 urges corresponding adjustment of linkage assembly 92 between the collapsed and extended configurations, non-rotation of adjustment member 140 in the collapsed configuration of linkage assembly 92 retains linkage assembly 92 in the collapsed configuration, and non-rotation of adjustment member 140 in the extended configuration of linkage assembly 92 retains linkage assembly 92 in the extended configuration.

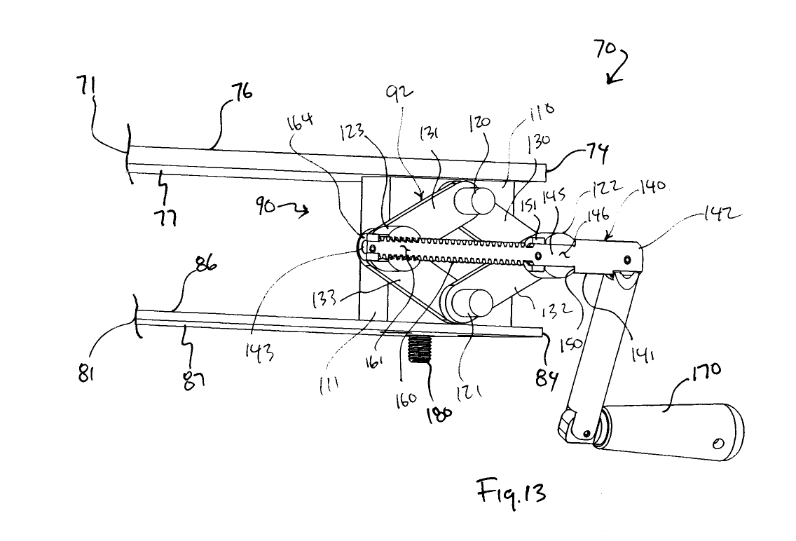

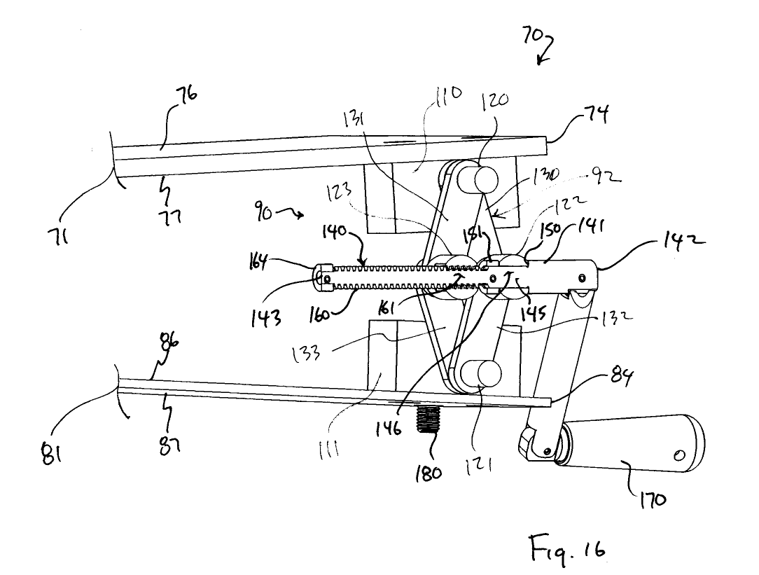

Referring to FIGS. 13 and 16, adjustment member 140 is connected to intermediate back and front pins 122 and 123 between the opposite diamond linkages. Adjustment member 140 includes an elongate shaft or member 141. Elongate shaft or member 141 has opposed inner and outer ends 142 and 143, neck 145 proximate to inner end 142, and externally threaded length or portion 160 between outer end 143 and neck 145. Externally threaded portion 160 extends from outer end 143 to neck 145. Neck 145 near inner end 142 extends through central opening 146 through intermediate back pin 122. Central opening 146 is equidistant between the opposite ends of intermediate back pin 122. Neck 145 extends between annular flange 150 formed in shaft 141 on the rearward side of intermediate back pin 122, and lock nut 151 encircling and secured to neck 145 on the forward side of intermediate back pin 122. Neck 145 of adjustment member 140 is free to rotate in opening 146 relative to intermediate back pin 122 so as to permit unrestrained rotation of shaft 141. Annular flange 150 and lock nut 151 on either side of intermediate back pin 122 and neck 145 together captively retain shaft 141 to intermediate back pin 122 so as to secure intermediate back pin 122 at a fixed position along the length of elongate shaft 140 at neck 145. Externally threaded portion 160 extends from outer end 143 to neck 145 where lock nut 151 is secured. Externally threaded portion 160 is threaded through a corresponding internally threaded central opening 161 through intermediate front pin 123. Externally threaded portion 160 is free to rotate in internally threaded opening 161 relative to intermediate front pin 123 and threadably interacts with internally threaded opening 161. Internally threaded opening 161 is equidistant between the opposite ends of intermediate front pin 123. Lock nut 164 encircles and is secured to outer end 143 of elongate shaft 141 on the forward side of intermediate front pin 123 so as to prevent externally threaded portion 160 from withdrawing from internally threaded opening 161 of intermediate front pin 123.

Linkage assembly 92 is adjustable between its collapsed and extended configurations in response to rotation of shaft 141 in opposite directions. With intermediate back pin 122 retained to shaft 141 at neck 145 and externally threaded portion 160 threaded through internally threaded opening 161, in response to rotation of shaft 141 in a counter-clockwise direction of rotation the threaded interaction between externally threaded portion 160 of shaft 141 and internally threaded opening 161 through intermediate front pin 123 urges intermediate front pin 123 along the length of shaft 141 toward outer end 143 away from intermediate back pin 122 until intermediate front pin 123 encounters lock nut 164 secured to outer end 143 of shaft 141 as in FIGS. 12 and 13 and each pair of blocks 110 and 111 on either side of linkage assembly 2 come into direct contact with one another, whereby the continued counter clockwise rotation of shaft 141 is restrained via the direct contact between the outer side of intermediate front pin 123 and lock nut 164 and the direct contact between each pair of blocks 110 and 111 on either side of linkage assembly 92. As a result of the pivotal connections between pins 120-123 and links 130-133 arranged in the diamond pattern as described, this described rotation of shaft 141 in the counter clockwise direction urges intermediate back and front pins 122 and 123 apart in the horizontal direction increasing the distance therebetween and urges upper and lower pins 120 and 121 together in the vertical direction decreasing the distance therebetween, thereby elongating/extending the opposed diamond linkages in the horizontal direction and shortening/collapsing the opposed diamond linkages in the vertical direction. As the vertical distance between upper and lower pins 120 and 121 decreases and the horizontal distance between intermediate back and front pins 122 and 123 increases collapsing linkage assembly 92 so as to extend or elongate it in the horizontal direction and shorten or collapse it in the vertical direction, platform 71 pivots at pivotal connection 91 so as to be tilted to its lowered or closed position at which point the direct contact between the outer side of intermediate front pin 123 and lock nut 164 in FIGS. 12 and 13 and the direct contact between each pair of blocks 110 and 111 on either side of linkage assembly 92 in FIGS. 10 and 11 sets platform 71 at the closed position and restrains further movement of platform 71 past the closed position.

In response to rotation of shaft 141 in a clockwise direction of rotation the threaded interaction between externally threaded portion 160 of shaft 141 and internally threaded opening 161 through intermediate front pin 123 urges intermediate front pin 123 along the length of shaft 141 toward intermediate back pin 122 away from outer end 143 of shaft 141 until the inner side of intermediate front pin 123 encounters lock nut 151 secured to shaft 141 along the outer side of intermediate back pin 122, whereby the continued clockwise rotation of shaft 141 is restrained via the direct contact between the inner side of intermediate front pin 123 and lock nut 151. As a result of the pivotal connections between pins 120-123 and links 130-133 arranged in the diamond pattern as described, this described rotation of shaft 141 in the clockwise direction urges intermediate back and front pins 122 and 123 together in the horizontal direction decreasing the distance therebetween and urges upper and lower pins 120 and 121 apart in the vertical direction increasing the distance therebetween, thereby shortening/collapsing the opposed diamond linkages in the horizontal direction and elongating/lengthening the opposed diamond linkages in the vertical direction. As the vertical distance between upper and lower pins 120 and 121 increases and the horizontal distance between intermediate back and front pins 122 and 123 decreases extending linkage assembly 92 so as to extend or elongate it in the vertical direction and shorten or collapse it in the horizontal direction, platform 71 pivots at pivotal connection 91 so as to be tilted from its lowered or closed position to its raised or inclined/tilted position at which point the direct contact between the inner side of intermediate front pin 123 and lock nut 151 in FIG. 16 sets platform 71 at the inclined position and restrains further movement of platform 71 past the inclined position. A crank or handle 170 is attached to inner end 142 of shaft 141, which may be taken up by hand for imparting rotation to shaft 141 of adjustment member 140.

And so in response to rotation of adjustment member 140 in opposite clockwise and counter clockwise directions, intermediate front pin 123 is made to reciprocate or otherwise translate back and forth along externally threaded portion 160 for adjusting linkage assembly back and forth from its collapsed configuration corresponding to the closed position of platform 71 and its extended configuration corresponding to the open tilted/inclined position of platform 71. Via the operation of adjustment member 140 as described, linkage assembly 92 can be set to its collapsed configuration to set platform 71 at its closed position, can be set to its extended configuration to set platform 71 at its inclined position, and can be set to any location between its collapsed and extended configurations for, in turn, setting platform 71 to any position between its closed position and its opened position. Through the attachment of adjustment member 140 to intermediate back pin 122 and the threaded interaction between externally threaded portion 160 of shaft 141 of adjustment member 140 and internally threaded opening 161 of intermediate front pin 123, in response the non-rotation of adjustment member 140 it retains linkage assembly 92 at its collapsed configuration to set and retain platform 71 at its closed position, it retains linkage assembly 92 at its extended configuration to set and retain platform 71 at its open tilted/inclined position, and it retains linkage assembly 92 at any position between the collapsed and extended configurations of linkage assembly 92 to, in turn, set and retain platform 71 at any position between its opened and closed positions.

Apparatus 70 is useful with lift device 50 in FIGS. 1 and 2. To install apparatus 70 with lift device 50, under surface 87 of base 81 is set atop load-supporting upper surface 60A of platform 60, and is releasably connected to platform 60 with wing bolts 180. In FIGS. 4 and 5, base 81 has four wing bolts 180 threaded through base 81 near the four respective corners of base 81. The winged ends of wing bolts 180 are between under surface 77 of platform 71 and upper surface 86 of base 81, and the threaded shanks of wing bolts 180 are threaded through base from upper surface to lower under surface 77 through corresponding threaded openings in base 81. The threaded shanks of wing bolts 180 are threaded into corresponding threaded openings in platform 60 of lift device 50, and are tightened via rotation by hand so as to releasably connect base 81, and thus apparatus 70, atop load-supporting upper surface 60A of platform 60. Although apparatus 70 is releasably connected atop load-supporting upper surface 60A of platform 60 with wing bolts 180, clamps brackets, or other form of mechanical fasteners can be used in alternate embodiments.

With base 81 set atop load-supporting upper surface 60A and connected to platform 60, apparatus 70 extends upwardly from base 81 and from load-supporting upper surface 60A of platform 60 to platform 71, which is held by retention assembly 90 at an elevated location above base 81 and above load-supporting surface 60A of platform 60. In the installation in FIGS. 1 and 2, the longitudinal dimension of platform 71 and base 81 from ends 74 and 84, respectively, to ends 75 and 85, respectively, extends across load-supporting upper surface 60A and platform 60 from one side of platform 60 at one side of lifting mast 51 of lift device 50 to the opposite side of platform 60 at the opposite side of lifting mast 51 of lift device 50, and the transverse dimension of platform 71 and base 81 from sides 72 and 83, respectively, to sides ends 73 and 83, respectively, extends across load-supporting upper surface 60A and platform 60 forwardly from lifting mast 51. In the closed position of platform 71 in FIG. 1 corresponding to the collapsed configuration of linkage assembly 92 discussed in detail above, platform 71 and load-supporting upper surface 76 of platform 71 are above and, in this example, parallel with respect to load-supporting upper surface 60 of platform 60 and also base 81 and upper surface 86 of base 81. In this closed position of platform 71, load-supporting upper surface 76 of platform 71 is available to take on a load to be lifted and lowered in the normal operation of lift device 50 according to the needs of the worker. To unload a load applied to load-supporting upper surface 76 of platform 71, a user may adjust linkage assembly 92 from its collapsed configuration to its extended configuration via the operation of adjustment member 140 so as to pivotally tilt platform 71, and thus load-supporting upper surface 76 of platform 71, from the closed position to the open inclined/tilted position in FIG. 2. In the opened inclined/tilted position of platform 71, platform 71 is inclined or otherwise tilted upwardly from end 75 at one side of lift device 50 to end 74 at the opposite side of lift device 50 relative to base 81, upper surface 86 of base 81, load-supporting upper surface 60A, and platform 60. In this opened position of platform 71, a load applied to load-supporting upper surface 76 of platform 71 may be oriented in preparation for being transferred from load-supporting upper surface 76 to a chosen landing area or installation location alongside lift device 50. The ability to tilt a load applied to load-supporting upper surface 76 of platform 71 by tilting platform 71, and thus load-supporting upper surface 76, from the closed position to the inclined opened position provides a safe and efficient way to orient a load in preparation for installation to a chosen location alongside lift device 50 from platform 71. After transferring the load from load-supporting upper surface 76 of platform 71 to the chosen landing area or installation location, linkage assembly 92 may be adjusted via the operation of adjustment member 140 from the extended configuration corresponding to the opened position of load-supporting upper surface 76 and platform 71 to the collapsed configuration corresponding to the closed position of load-supporting upper surface 76 and platform 71 in preparation for setting a load to be lifted onto load-supporting upper surface 76 of platform 71. This process may be repeated for lifting and unloading loads depending on the needs of the worker.

In the present embodiment in FIGS. 1 and 2, apparatus 70 is installed such that the longitudinal dimension of platform 71 and base 81 from ends 74 and 84, respectively, to ends 75 and 85, respectively, extends across load-supporting upper surface 60A and platform 60 from one side of platform 60 at one side of lifting mast 51 of lift device 50 to the opposite side of platform 60 at the opposite side of lifting mast 51 of lift device 50, and the transverse dimension of platform 71 and base 81 from sides 72 and 83, respectively, to sides ends 73 and 83, respectively, extends across load-supporting upper surface 60A and platform 60 forwardly from lifting mast 51. If desired, the described installation orientation of apparatus 50 can be reversed in the opposite direction without departing from the invention. In other embodiments, apparatus 70 may be installed in other orientations on load-supporting upper surface 60A of platform 60 as may be desired depending on the needs of the worker.

In the closed position of platform 71 in FIG. 1 corresponding to the collapsed configuration of linkage assembly 92 discussed in detail above, platform 71 and load-supporting upper surface 76 of platform 71 are parallel with respect to load-supporting upper surface 60 of platform 60 and also base 81 and upper surface 86 of base 81. In other embodiments, in the closed position of platform 71, platform 71 and load-supporting upper surface 76 of platform 71 may be concurrently inclined downwardly from the horizontal from end 75 to end 74 with respect to load-supporting upper surface 60 of platform 60 and also base 81 and upper surface 86 of base 81.

It is to be emphasized that the ability to tiltably adjust platform 71, and thus load-supporting upper surface 76 of platform 71, from the closed position to the opened positions allows a worker to adjust the tilt of platform 71, and thus load-supporting upper surface 76 of platform 71, as needed in order to level a load applied to upper surface 76 of platform 71 if needed, and, if needed, to orient a load applied to load-supporting upper surface 76 of platform 71 to a pre-selected orientation corresponding to the pre-selected tilt of platform 71 and, thus, load-supporting upper surface 76 of platform 71. This ability to tiltably orient a load applied to load-supporting upper surface 76 of platform 71 via the use of apparatus 70 provides worker with the ability to orient a load in a specific orientation depending on specific needs.

Some fixed equipment mounting locations consist of racks, frameworks, or cabinets having extendible supports or rails, fashioned with specialized mounting points, such as slots, “drop-ins”, through-hole mounting features, or the like, to receive corresponding equipment mounts of a piece of equipment. Apparatus 70 is useful for selectively aligning the equipment mounts of a piece of equipment applied to load-supporting upper surface 76 of platform 71 with corresponding mounting points of the chosen mounting location during installation and removal operations. This is accomplished by adjusting/changing the inclination of platform 71 via the operation of apparatus 70 for, in turn, adjusting the orientation of the equipment applied to load-supporting upper surface 76 of platform 71 for selectively and/or sequentially aligning the equipment mounts of the piece of equipment with the corresponding mounting points during installation, and for selectively and/or sequentially detaching the equipment mounts of the piece of equipment from the corresponding mounting points.

In a particular example, apparatus 70 is set to the closed position, a piece of equipment is placed onto load-supporting upper surface 76 of platform 71 for transport in a horizontal orientation corresponding to the horizontal orientation of platform 71 and, thus, load-supporting upper surface 76 of platform 71, lift device 50 is moved to a mounting location, and platform 60 onto which apparatus 70 is set is raised or lowered via the operation of lift device 50 to register the piece of equipment applied atop load-supporting upper surface 76 of platform 71 relative to the mounting location. Platform 71 is then tilted from the closed position via the operation of apparatus 70 to orient first equipment mounts of the piece of equipment with corresponding first mounting points of the mounting location. Platform 60 is then raised or lowered via the operation of lift device 50 so as to set the first equipment mounts into the corresponding first mounting points. At this point, platform 71 is tilted, upwardly or down as my be needed, for, in turn, orienting second equipment mounts of the piece of equipment with corresponding second mounting points of the mounting location. Platform 60 is then raised or lowered via the operation of lift device 50 so as to set the second equipment mounts into the corresponding second mounting points thereby mounting the piece of equipment at the mounting location. Having completed the installation, platform 60 is then lowered via the operation of lift device 50 so as to free the piece of equipment from atop load-supporting upper surface 76 of platform 71, at which point lift device 50 may be moved away from the mounting location. This installation process may be repeated as necessary, and is simply reversed for removing the piece of equipment from the mounting location. Similar processes may be carried out in the installation of various forms of equipment.

The various embodiments of the present invention are presented herein for illustrative purposes. Those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A lift apparatus, comprising:
a lift device operable for raising and lowering a first platform;
a base connected atop the first platform;
a second platform mounted to the base for tiltable movement between a first position and a second position relative to the first platform, the second position of the second platform being tilted relative to the first position of the second platform; and
a retention assembly coupled between the base and the second platform for selectively tilting the second platform from the first position to the second position, and selectively retaining the second platform in the first position and in the second position.

2. The lift apparatus according to claim 1, wherein the retention assembly comprises:
a pivot connection connecting the second platform to the base for pivotal tilting movement of the second platform between the first position and the second position;
a linkage assembly interacting between the base and the second platform, the linkage assembly is adjustable between a collapsed configuration and an extended configuration for imparting corresponding pivotal movement of the second platform at the pivot connection from the first position to the second position;
the pivot connection and the collapsed configuration of the linkage assembly cooperate to retain the second platform in the first position; and
the pivot connection and the extended configuration of the linkage assembly cooperate to retain the second platform in the second position.

3. The lift apparatus according to claim 2, further comprising means coupled to the linkage assembly for selectively retaining the linkage assembly in the collapsed and extended configurations, and selectively adjusting the linkage assembly between the collapsed and extended configurations.

4. The lift apparatus according to claim 3, wherein the means comprises an adjustment member rotatably carried by the linkage assembly, wherein rotation of the adjustment member urges corresponding adjustment of the linkage assembly between the collapsed and extended configurations, non-rotation of the adjustment member in the collapsed configuration of the linkage assembly retains the linkage assembly in the collapsed configuration, and non-rotation of the adjustment member in the extended configuration of the linkage assembly retains the linkage assembly in the extended configuration.

5. The lift apparatus according to claim 2, further comprising blocks for interacting between the second platform and the base in the first position of the second platform for limiting movement of the second platform past the first position in a direction toward the first platform.

6. The lift apparatus according to claim 5, wherein the blocks comprise a first pair of blocks carried by the second platform aligned with a second pair of blocks carried by the base.

7. The lift apparatus according to claim 6, wherein the linkage assembly is connected to the first blocks and to the second blocks.

8. The lift apparatus according to claim 4, further comprising a handle connected to the adjustment member, the handle being available to be taken up by hand for imparting rotation to the adjustment member.

9. A lift apparatus, comprising:
a lift device operable for raising and lowering a first platform;
a base connected atop the first platform, the base having opposed first and second ends;
a second platform having opposed first and second ends;
a pivot connection connecting the second platform proximate to the first end thereof to the base proximate to the first end thereof for selective pivotal tilting movement of the second platform between a first position and a second position relative to the first platform, the second position of the second platform being tilted relative to the first position of the second platform;
a linkage assembly interacting between the base and the second platform proximate to the second end of the base and the second end of the second platform, the linkage assembly is adjustable between a collapsed configuration and an extended configuration for imparting corresponding pivotal tilting movement of the second platform at the pivot connection from the first position to the second position;
the pivot connection and the collapsed configuration of the linkage assembly cooperate to retain the second platform in the first position; and
the pivot connection and the extended configuration of the linkage assembly cooperate to retain the second platform in the second position.

10. The lift apparatus according to claim 9, further comprising means coupled to the linkage assembly for selectively retaining the linkage assembly in the collapsed and extended orientations, and selectively adjusting the linkage assembly between the collapsed and extended orientations.

11. The lift apparatus according to claim 10, wherein the means comprises an adjustment member rotatably carried by the linkage assembly, wherein rotation of the adjustment member urges corresponding adjustment of the linkage assembly between the collapsed and extended orientations, non-rotation of the adjustment member in the collapsed orientation of the linkage assembly retains the linkage assembly in the collapsed orientation, and non-rotation of the adjustment member in the extended orientation of the linkage assembly retains the linkage assembly in the extended orientation.

12. The lift apparatus according to claim 9, further comprising blocks for interacting between the second platform and the base in the first position of the second platform for limiting movement of the second platform past the first position in a direction toward the first platform.

13. The lift apparatus according to claim 12, wherein the blocks comprise a first pair of blocks carried by the second platform aligned with a second pair of blocks carried by the base.

14. The lift apparatus according to claim 13, wherein the linkage assembly is connected to the first blocks and to the second blocks.

15. The lift apparatus according to claim 11, further comprising a handle connected to the adjustment member, the handle being available to be taken up by hand for imparting rotation to the adjustment member.
